(19) United States
(12) Patent Application Publication
(10) Pub. No.: US 2021/0009184 A1
(43) Pub. Date: Jan. 14, 2021

(54) MULTIFUNCTIONAL MOTORIZED STROLLER

(71) Applicant: Sherice Givens, Thomasville, PA (US)

(72) Inventor: Sherice Givens, Thomasville, PA (US)

(21) Appl. No.: 16/505,291

(22) Filed: Jul. 8, 2019

(51) Int. Cl. B62B 7/04; B62B 9/08; B62B 9/26; B62B 5/00; B62B 9/14; B60L 1/00; B60L 8/00; H02J 7/00; H02J 7/35; F21V 33/00

(52) U.S. Cl. CPC B62B 7/04; H02S 99/00; B62B 9/26; B62B 5/0036; B62B 5/0053; B62B 9/14; B60L 1/00; B60L 8/003; H02J 7/0052; H02J 7/355; F21V 33/0004; B62B 2204/02; B62B 2204/04; B60L 2200/20; B62B 9/087

(57) ABSTRACT

A multifunctional motorized stroller device including a stroller body frame including a motor member, a braking member, a handle member, a canopy member, wheel frame member and a seating member. The motor member provides propulsion to the device. The braking member ceases movement of the device. The handle member having a push button start element to activate the motor and an emergency brake activator element for activating the braking element. The canopy member having at least one cup holder element, a universal serial bus (USB) charging element for charging electronic devices and a solar panel element for providing electricity to the device. The wheel frame member having a plurality of wheel elements, a battery element and at least one pair of fan elements for cooling the device. The seating member having a removable seat cover.

### FIELD OF THE INVENTION

Embodiments described herein generally relate to a stroller, and more particularly to a multifunctional motorized stroller.

### BACKGROUND OF THE INVENTION

Parents often put babies in their strollers and push them as a method of soothing and calming. However, if a parent or caregiver is in the middle of another activity, it can become difficult to manage both at the same time, which creates a burden for both adult and child. Hence, it is desirable to provide a multifunctional stroller which allows a parent or caregiver to multitask while transporting a child.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a multifunctional motorized stroller device according to an embodiment of the present disclosure.

### SUMMARY OF THE INVENTION

Exemplary embodiments disclosed herein describe a multifunctional motorized stroller device including a stroller body frame including a motor member, a braking member, a handle member, a canopy member, wheel frame member and a seating member. The motor member provides propulsion to the device. The braking member ceases movement of the device. The handle member having a push button start element to activate the motor and an emergency brake activator element for activating the braking element. The canopy member having at least one cup holder element, a universal serial bus (USB) charging element for charging electronic devices and a solar panel element for providing electricity to the device. The wheel frame member having a plurality of wheel elements, a battery element and at least one pair of fan elements for cooling the device. The seating member having a removable seat cover.

In some exemplary embodiments, the device includes a footrest member having at least one pair of lighting elements integrated therein.

In some exemplary embodiments, the canopy member includes a pair of cup holder elements, wherein one cup holder element has a cooling mechanism and the other cup holder element has a heating mechanism.

In some exemplary embodiments, the emergency brake activator element includes a wrist strap to be worn by the operator of the device.

In some exemplary embodiments, the wrist strap is connected to a key which is removed from the device when the operator pulls the wrist strap.

In some exemplary embodiments, the braking member causes the wheel elements to stop when the key is removed from the device.

In some exemplary embodiments, the USB charging element is a USB connector which receives a USB cable for connection to another device.

In some exemplary embodiments, the USB connectors draws electricity from either the battery or solar panel to charge the connected device.

In some exemplary embodiments, the plurality of wheel elements are all-terrain.

In some exemplary embodiments, the device may be operated manually or motorized.

### DETAILED DESCRIPTION

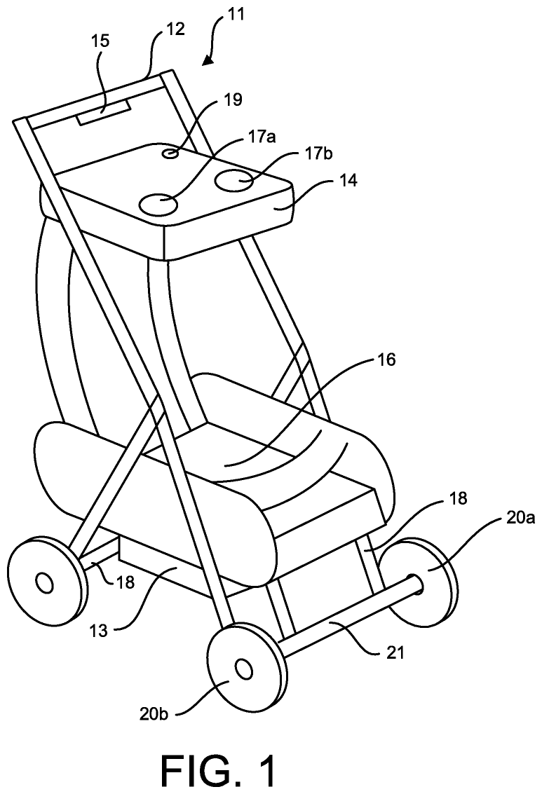

The present disclosure relates to a multifunctional stroller device (“the device”). As illustrated in FIG. 1, the device 10 includes a stroller body frame 11 including a motor member 13, a braking member (not shown), a handle member 12, a canopy member 14, a wheel frame member 18 and a seating member 16. The motor member provides propulsion to the device, causing the plurality of wheel elements 20 to propel. The motor member may be located under the seating member 16. The motor member may be activated by the push-button start element 15. Any suitable motor may be used with the device.

The braking member halts movement of the device. The braking member stops the plurality of wheel elements from moving. The braking member may be an anti-braking system, which automatically stops any motion of the plurality of wheel elements 20 when an emergency brake activator element is activated. The emergency brake activator element may be activated by removing a key from the device.

The handle member 12 includes a push button start element 15 to activate the motor member 13 and an emergency brake activator element (not shown) for activating the braking member. Upon depressing the push button start element, the motor member turns on and the plurality of wheels are propelled. Alternatively, the device may be operated in a manual mode where the mode is turned off.

The emergency brake activator element includes a wrist strap which is to be worn by the operator of the device. The wrist strap is connected to a key which is connected to the device. The emergency brake activator element is activated when the key is removed from the device. The key is removed from the device when the operator pulls the wrist strap. Once the key is removed from the device, the braking member automatically halts any movement of the plurality of wheel elements.

The canopy member 14 includes at least one cup holder element 17, a universal serial bus (USB) charging element 19 for charging electronic devices and a solar panel element (not shown) for providing electricity to the device 10. In a preferred embodiment, the canopy member includes at least one pair of cup holder elements 17a and 17b, where one cup holder element has a cooling mechanism and the other cup holder element has a heating mechanism. The cooled cup holder element many be used to keep an item cooled, such as, for example, water, juice, or formula. The heated cup holder element may be used to warm a bottle.

The USB charging element 19 is a USB connector which is configured to receive a USB cable for connection to another device, such as, for example, a smart/mobile phone, a tablet, or any other electronic device. The USB connector draws electricity from either a battery element (not shown) or a solar panel element (not shown) to charge the connected device. The solar panel element provides electricity to the device. Moreover, the device 10 includes a battery (not shown) for providing power to the device. Any suitable type of battery may be used. In a preferred embodiment, the battery is a water-based lithium ion battery.

In another exemplary embodiment, the canopy member 14 includes a retractable USB cable and a Bluetooth enabled speaker.

The wheel frame member 18 includes a plurality of wheel elements 20a-c (also includes 20d not shown) and at least one pair of fan elements (not shown) for cooling the device. Any suitable wheels may be used. In a preferred embodiment, the plurality of wheels are all-terrain. Any suitable fans may be used for cooling the device.

The seating member 16 includes a removable seat cover. In a preferred embodiment, the seat cover is machine washable.

In another exemplary embodiment, the device 10 includes a cooler compartment for storing and cooling one or more items.

In another exemplary embodiment, the device 10 includes a footrest member 21 having at least one pair of lighting elements (not shown) integrated therein. The lights run in the daytime and during the nighttime. Any suitable lighting mechanisms may be used for providing light.

In another exemplary embodiment, the device includes a five (5) point harness for strapping in the seat occupier.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A multifunctional motorized stroller device comprising:
a stroller body frame including a motor member for providing propulsion to the device, a braking member for ceasing movement of the device, a handle member having a push button start element to activate the motor and an emergency brake activator element for activating the braking member, a canopy member having at least one cup holder element, a universal serial bus (USB) charging element for charging electronic devices and a solar panel element for providing electricity to the device, a wheel frame member having a plurality of wheel elements, a battery element and at least one pair of fan elements for cooling the device, and a seating member having a removable seat cover.

2. The device of claim 1, further comprising a footrest member having at least one pair of lighting elements integrated therein.

3. The device of claim 1, wherein the canopy member includes a pair of cup holder elements, wherein one cup holder element has a cooling mechanism and the other cup holder element has a heating mechanism.

4. The device of claim 1, wherein the emergency brake activator element includes a wrist strap to be worn by an operator of the device.

5. The device of claim 4, wherein the wrist strap is connected to a key which is removed from the device when the operator pulls the wrist strap.

6. The device of claim 5, wherein the braking member causes the plurality of wheel elements to stop when the key is removed from the device.

7. The device of claim 1, wherein the USB charging element is a USB connector which receives a USB cable for connection to another device.

8. The device of claim 7, wherein the USB connector draws electricity from either the battery element or solar panel element to charge the connected device.

9. The device of claim 1, wherein the plurality of wheel elements are all-terrain.

10. The device of claim 1, wherein the device may be operated manually or motorized.
